(19) United States
(12) Patent Application Publication
(10) Pub. No.: US 2009/0039125 A1
(43) Pub. Date: Feb. 12, 2009

(54) DEVICE FOR MOUNTING BICYCLE ACCESSORIES

(76) Inventors: Olivier Bock, Hood River, OR (US); Guntram Jordan, Hood River, OR (US)

Correspondence Address: HUSCH BLACKWELL SANDERS LLP, 4801 Main Street, Suite 1000, KANSAS CITY, MO, 64112, US

(21) Appl. No.: 11/834,510

(22) Filed: Aug. 6, 2007

(51) Int. Cl. B60R 11/00; A47B 96/06

(52) U.S. Cl. 224/275; 248/222.11

(57) ABSTRACT

A device for removably mounting bicycle accessories is provided that includes a latching member, a retention plate member, and a mounting bracket. The latching member has a pull handle, a deflectable spring structure, and a latching tab. The spring structure has one end attached to the pull handle and the other end attached to a latching tab. The plate member is configured for attaching the latching member to an accessory. The mounting bracket has an insertion end, a latching end, and channels for slidably receiving the retention plate member and is configured for being attached to a bicycle. The mounting bracket latching end is configured for being engaged by the latching tab of the latching member. Further, the pull handle is configured for causing deflection of the spring structure and inward retraction of the latching tabs.

### CROSS-REFERENCE TO RELATED APPLICATIONS

None.

### BACKGROUND OF THE INVENTION

It is often desirable to removably couple two articles together. For example, bicycle riders often desire to removably couple accessories and articles to their bicycles. They often attach accessories such as odometers, tachometers, global positioning system receivers, water bottles, and small bags to their bicycles. The accessories are many times attached to the bicycle's frame, handlebars, or under its seat. When the accessories are not needed, riders may desire to exclude them from their bicycles completely. Additionally, both for convenience and security, riders may desire to temporarily remove the accessories, such as bags containing valuable personal items, whenever they are away from their bicycles for an extended period of time. In such cases, it is desirable for the accessories to be easily and quickly removable and replaceable on the bicycle.

An assortment of devices for removably coupling two articles together are known. Some of these devices allow accessories and articles to be attached to a bicycle. However, many of these known devices make it difficult to remove and attach accessories and articles to a bicycle and are unduly complex, bulky, and expensive to produce. Moreover, the portion of some of these devices containing the movable latching component is the portion that remains affixed to the bicycle, thus subjecting the movable latching component to the elements of the weather.

Accordingly, a need exists for a device for removably coupling two articles together that provides an easy way to remove and attach accessories and articles to a bicycle, is of a simple construction, is of a smaller form, and is less expensive to produce. A further need exists for a device for removably coupling two articles together in which the portion containing the movable latching component is the portion affixed to the accessory, rather than to the bicycle.

### SUMMARY OF THE INVENTION

An embodiment of the present invention is directed to a device for removably coupling articles that includes a latching member, a retention plate, and a mounting bracket. The latching member has a pull handle, a deflectable spring structure, and at least one latching tab. One embodiment of the spring structure as disclosed herein can have an arc-shaped cantilever-type leaf spring extending from the pull handle to a distal end where the latching tab is located. Also attached to the latching tab is a deflection arm that extends from a distal end back toward the pull handle to a stop end. The retention plate is configured for attaching the latching member to a first article. One embodiment of the retention plate can have a containment area for capturing the spring structure. The plate containment area can have an opening adjacent the retaining tab through which the retaining tab can extend for a locking engagement with the mounting bracket. The plate containment area can have a further opening through which the pull handle can extend for access by the user. The mounting bracket has an insertion end, a latching end, and at least one channel for slidably receiving the retention plate and is configured for being attached to a second article. The bracket latching end is configured for being engaged by the latching tabs of the latching member. The latching member pull handle is configured for causing deflection of the spring structure such that the latching tab is deflected from a latching position to an unlatching position as the pull handle is slidably pulled from a first spring equilibrium position to a second spring deflection unlatching position.

Another embodiment of the present invention is directed to a mounting bracket for removably mounting articles that includes an insertion end, a latching end, and at least one channel configured for slidably receiving an assembly having a retention plate and a latching member with a latching tab. The mounting bracket also includes a means for mounting the bracket to an object. One embodiment of the mounting bracket as disclosed herein can have mounting means with a loop strap clamp configured for clamping to a tubular member. Another embodiment of the mounting bracket can have mounting means that includes recessed portions of the mounting bracket configured for engaging a lower portion of cycle seat frame rods and a rod-engaging member configured for engaging an upper portion of the rods.

A further embodiment of the present invention is directed to an assembly for removably coupling articles that includes a latching member and a retention plate. The assembly is configured for being slidably received by a mounting bracket having at least one channel. The latching member has a pull handle, a deflectable spring structure, and at least one latching tab. One embodiment of the spring structure as disclosed herein can have an arc-shaped cantilever-type leaf spring extending from the pull handle to a distal end where the latching tab is located. Also attached to the latching tab is a deflection arm that extends from a distal end back toward the pull handle to a stop end. The retention plate is configured for attaching the latching member to a first article. One embodiment of the retention plate can have a wall and standoffs protruding from the wall to create a containment area for capturing the spring structure between the wall and an article to which the retention plate is attached. The plate containment area can have an opening adjacent said retaining tab through which the retaining tab can extend for a locking engagement with the mounting bracket. The plate containment area can have a further opening through which the pull handle can extend for access by the user.

### DESCRIPTION OF THE SEVERAL VIEWS OF THE DRAWINGS

Further features of the present invention will become apparent to those skilled in the art to which the present invention relates from reading the following description with reference to the accompanying drawings, in which:

FIG. 1 is an exploded left perspective view of a device for mounting bicycle accessories showing the manner in which the device can be used to attach a bag to a bicycle seat in accordance with one embodiment of the present invention;

FIG. 2 is a plan view of a latching member and retention plate assembly showing the latching member spring structure in a natural, undeflected state in accordance with one embodiment of the present invention;

FIG. 3 is a plan view of a latching member and retention plate assembly showing the latching member spring structure in a deflected state in accordance with one embodiment of the present invention;

FIG. 4. is a left perspective view of a device for mounting bicycle accessories showing a portion of the device secured to a bicycle seat and a portion of the device secured to a bag in accordance with one embodiment of the present invention;

FIG. 5 is an assembled left perspective view of a device for mounting bicycle accessories showing a bag mounted to a bicycle seat in accordance with one embodiment of the present invention;

FIG. 6 is an exploded left perspective view of a device for mounting bicycle accessories showing the manner in which the device can be used to attach a bag to bicycle handlebars in accordance with one embodiment of the present invention;

FIG. 7 is a left perspective view of a device for mounting bicycle accessories showing a portion of the device secured to bicycle handlebars and a portion of the device secured to a bag in accordance with one embodiment of the present invention; and

FIG. 8 is an assembled left perspective view of a device for mounting bicycle accessories showing a bag mounted to bicycle handlebars in accordance with one embodiment of the present invention.

### DETAILED DESCRIPTION OF THE INVENTION

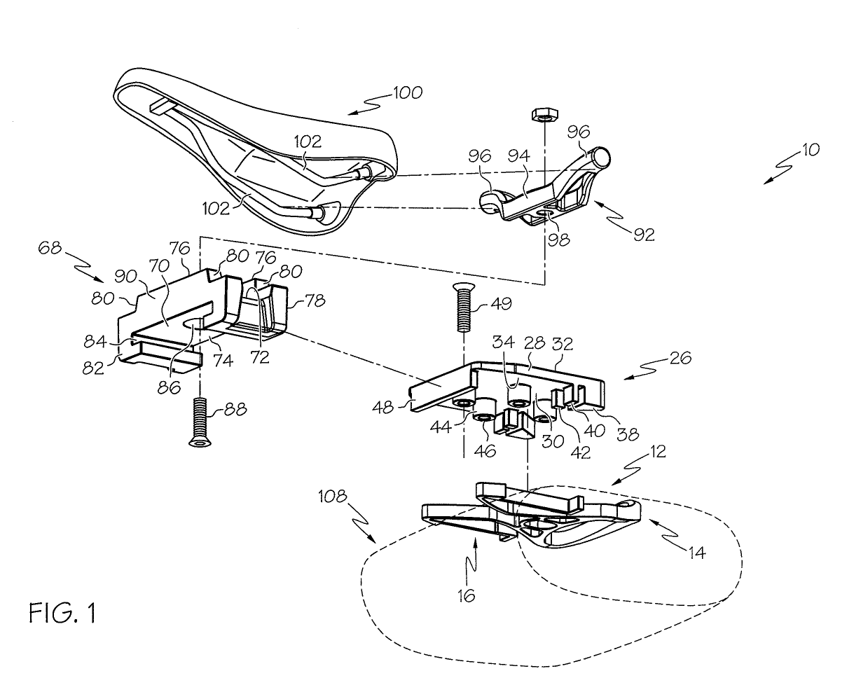

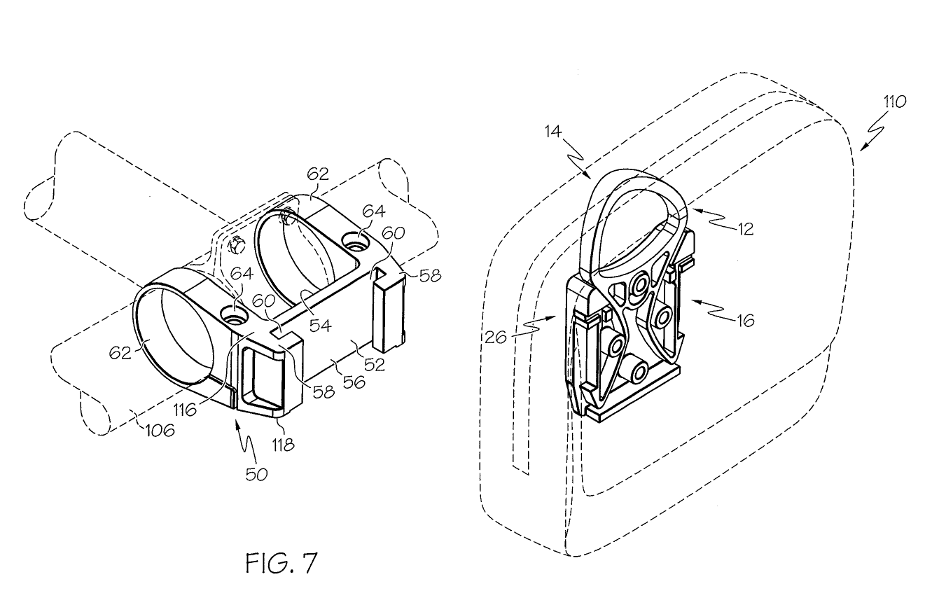

According to the embodiment(s) of the present invention, various views are illustrated in FIGS. 1-8 and like reference numerals are being used consistently throughout to refer to like and corresponding parts of the invention for all of the various views and figures of the drawing.

One embodiment of the present invention comprising a latching member 12, a retention plate member 26, and a mounting bracket 68 teaches a novel apparatus for removably coupling two articles together. In particular, one embodiment of the present invention may be used for removably mounting accessories, such as odometers, tachometers, global positioning system receivers, water bottles, bags to a bicycle. Each of the embodiments of the present invention include the same general concepts. It will therefore be appreciated that in the drawings and the following descriptions, like reference numbers will be used on like components in the different embodiments of the present invention.

The details of the invention and various embodiments can be better understood by referring to the figures of the drawing. Referring to FIG. 1, the mounting device 10 includes a releasable latching member 12, a retention plate member 26, and a mounting bracket 68. In one embodiment, the latching member 12 and the retention plate member 26 are secured to an accessory 108 and the mounting bracket 68 is secured to a bicycle. The retention plate member 26 is configured for attaching the latching member 12 to an accessory 108. The mounting bracket 68 is configured for attachment to a bicycle and for receiving retention plate member 26. Upon the retention plate member 26 becoming fully received by the bracket 68, the latching member 12 engages the mounting bracket 68 thereby causing the latching member 12, the retention plate 26, and the accessory 108 to which they are attached to become releasably secured to the bracket 68.

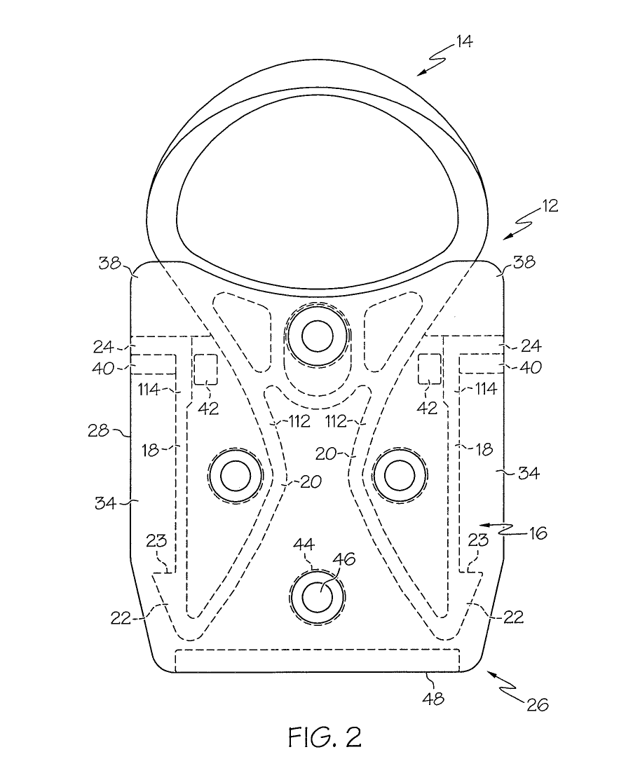

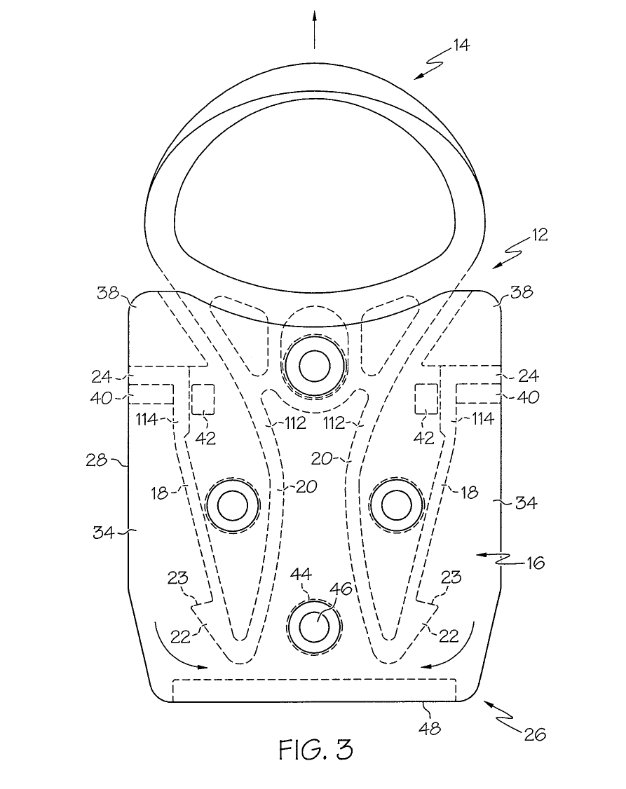

As mentioned, each embodiment of the device 10 includes a latching member 12 and a retention plate member 26. As illustrated in FIGS. 2-3, the latching member 12 includes a pull handle 14, a deflectable spring structure 16, latching tabs 22, and stop ends 24. The deflectable spring structure 16 can include a pair of arc-shaped cantilever-type leaf springs 20 and a pair of deflection arms 18. The cantilever-type leaf springs 20 are attached at one of their ends to the pull handle 14, extend away from the pull handle 14 to distal ends, and at the distal ends are attached to latching tabs 22. In one embodiment, the arc-shaped cantilever-type leaf springs 20 have a medial inward apex. The deflection arms 18 are attached at one end to latching tabs 22 and extend back toward the pull handle 14 to outwardly projecting stop ends 24.

As shown in FIGS. 2-3, the latching tabs 22 can each have an engagement surface 23. The engagement surfaces 23 are configured for engaging the latching end 90,118 of a mounting bracket 50, 68. As shown in FIGS. 2-3, the engagement surfaces 23 can be substantially perpendicular to the longitudinal axis of the latching member 12 when the spring structure 16 is in its natural, undeflected state. The engagement surfaces 23 may also be configured at other angles. For example, the engagement surfaces 23 may be configured at angles less than 90 degrees from the longitudinal axis of the latching member 12 when the spring structure 16 is in its natural, undeflected state. In such a case, the outer edges of the engagement surfaces 23 are configured for engaging the latching end 90, 118 of mounting bracket 50, 68. The latching tabs 22 can also have a beveled or wedge-shaped form to facilitate engagement with the channels 60, 84 of a mounting bracket 50, 68.

As shown in FIG. 1, the retention plate member 26 includes a wall 28 having a first surface 30 and a second surface 32. The retention plate member 26 has projections 40, 42 protruding from its first surface 30 for holding the latching member stop ends 24 in place. Additionally, the retention plate 26 includes stops 38 protruding from its first surface 30 for transferring force from the pull handle 14 to the spring structure 16.

One embodiment of the retention plate 26 can have a containment area for capturing the latching member spring structure 16. Standoffs 44 can be provided to create a containment area between the wall 28 and the accessory 108 to which the retention plate member 26 is secured. The plate containment area can have openings adjacent the retaining tabs 22 through which the retaining tabs 22 can extend for a locking engagement with the mounting bracket 50, 68. The plate containment area can have a further opening through which the pull handle 14 can extend for access by the user. Each of the standoffs 44 can have countersunk apertures 46 for receiving screws or bolts 49 that secure the retention plate member 26 to an accessory 108. The retention plate member wall 28 has side flange portions 34 for being slidably received in the channels 60, 84 of a mounting bracket 50, 68. The retention plate member 26 may also include an end wall 48.

As illustrated in FIG. 3, when the latching member handle 14 is pulled, the spring structure 16 becomes deflected. This deflection is caused by the spring structure second ends 114 being held in place by the stop ends 24 while the spring structure first ends 112 are displaced by the movement of the handle 14. As shown, when the handle 14 is pulled, the cantilever-type leaf springs 20 deflect into a straighter, less arced shape. This deflection causes the latching tabs 22 to retract inwardly to an unlatching position. In turn, the inward retraction of the latching tabs 22 causes them to release and become unengaged from a mounting bracket 50, 68.

As shown in FIGS. 1, 4-5, one embodiment of the device 10 may be used to removably mount accessories under a bicycle's seat 100. As illustrated, the embodiment includes a latching member 12 and a retention plate member 26 secured to a bag 108. The embodiment also includes a mounting bracket 68 and a rod-engaging member 92.

The mounting bracket 68 is configured for being positioned below the bicycle seat's frame rods 102. The mounting bracket 68 includes an insertion end 78 and a latching end 90. The mounting bracket 68 has a wall 70 with a first surface 72 and a second surface 74 and a pair of longitudinal sidewalls 76 protruding from the first surface 72. The longitudinal sidewalls 76 can have recesses 80 at each of their ends that are configured for engaging a lower portion of the seat frame rods 102. The mounting bracket 68 also includes flanges 82 protruding from the wall second surface 74. The flanges 82 have channels 84 extending from the insertion end 78 to the latching end 90 that are configured for slidably receiving the retention plate member 26. As illustrated in FIGS. 1, 4-5, the channels 84 have a width slightly greater than the thickness of the retention plate side flange portions 34. Additionally, the mounting bracket 68 can define an aperture 86 through its wall 70 for receiving a bolt 88 suitable for coupling the mounting bracket 68 and rod-engaging member 92 together.

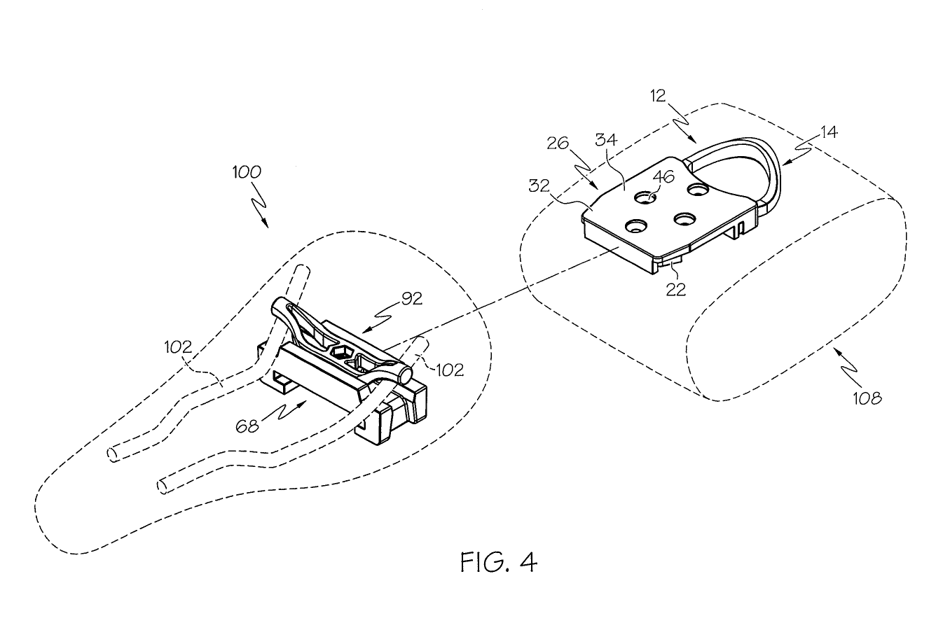

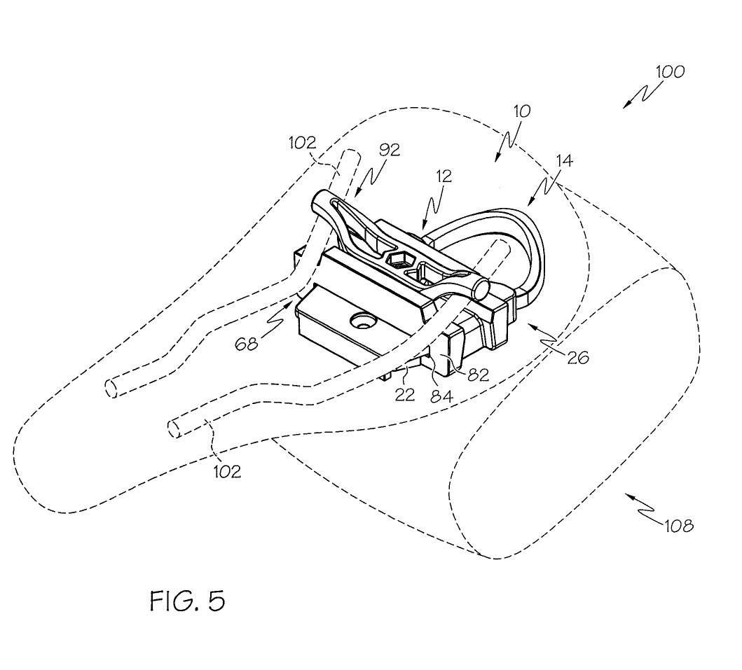

The rod-engaging member 92 has a medial portion 94 and two arms 96 protruding therefrom. The rod-engaging member 92 is configured for being positioned above the seat frame rods 102 of a bicycle seat 100. The arms 96 are configured for engaging an upper portion of the seat frame rods 102 as illustrated in FIGS. 4-5. As shown in FIG. 1, the rod-engaging member 92 can define an aperture 98 through its medial portion 94 for receiving a bolt 88 suitable for coupling the rod-engaging member 92 and the mounting bracket 68 together. It will be appreciated by one skilled in the art that the rod-engaging member 92 and the mounting bracket 68 can be coupled together by other means including screws, pins, cable ties, wire, welding, clamps, clips, adhesives, or any other means suitable for use with the present invention.

As illustrated in FIGS. 4-5, the mounting bracket 68 and rod-engaging member 92 can be coupled together such that the seat frame rods 102 are fixed therebetween. When the mounting bracket 68 and rod-engaging member 92 are coupled together, the seat frame rods 102 are clamped between the arms 96 and the sidewall recesses 80.

When a user desires to couple an accessory, such as a bag 108, underneath the seat 100 of a bicycle, the user joins the retention plate 26 (which is secured to the accessory) with the mounting bracket 68 (which is secured to the seat 100). In doing so, the user slides the side flange portions 34 of the retention plate 26 into the respective channels 84 of the mounting bracket 68. When initially inserting the side flange portions 34 into the channels 84, the latching tabs 22 of the latching member 12 will engage the channels 84. This engagement forces the latching tabs 22 to be inwardly displaced. When the latching tabs 22 are inwardly displaced, the spring structure 16 becomes deflected. The beveled shape of the latching tabs 22 helps to guide the latching tabs 22 inwardly and transition the spring structure 16 into its deflected state as the latching tabs 22 first enter the channels 84. Once the latching tabs 22 completely pass through the channels 84, the spring structure 16 returns to its natural, undeflected state. When this occurs, the latching tabs 22 snap outwardly to a latching position and engage against latching end 90 of the mounting bracket 68 as shown in FIG. 5. This engagement secures the retention plate member 26 to the mounting bracket 68, which again is secured to the seat 100 of the bicycle.

When a user desires to uncouple the accessory from the seat 100 of a bicycle, the user detaches the retention plate member 26 (which is secured to the accessory) from the mounting bracket 68 (which is secured to the seat 100). To do so, the user pulls the latching member handle 14. Again, as illustrated in FIG. 3, when the latching member handle 14 is pulled, the spring structure 16 becomes deflected. As described above, this deflection is caused by the spring structure second ends 114 being held in place by the stop ends 24 while the spring structure first ends 112 are displaced by the movement of the handle 14. As shown in FIG. 3, when the handle 14 is pulled, the cantilever-type leaf springs 20 deflect into a straighter, less arced shape. This deflection causes the latching tabs 22 to retract inwardly to an unlatching position. In turn, the inward retraction of the latching tabs 22 causes them to release and become disengaged from latching end 90 of the bracket 68.

The pulling force applied by the user to the latching member handle 14 to release the latching tabs 22 also acts to pull the retention plate 26 out from the bracket channels 84. Therefore, the latching member 12 and the retention plate 26 can be disengaged and separated from the mounting bracket 68 with a single pulling action. This may allow a user to uncouple an accessory from a bicycle with the use of only one hand.

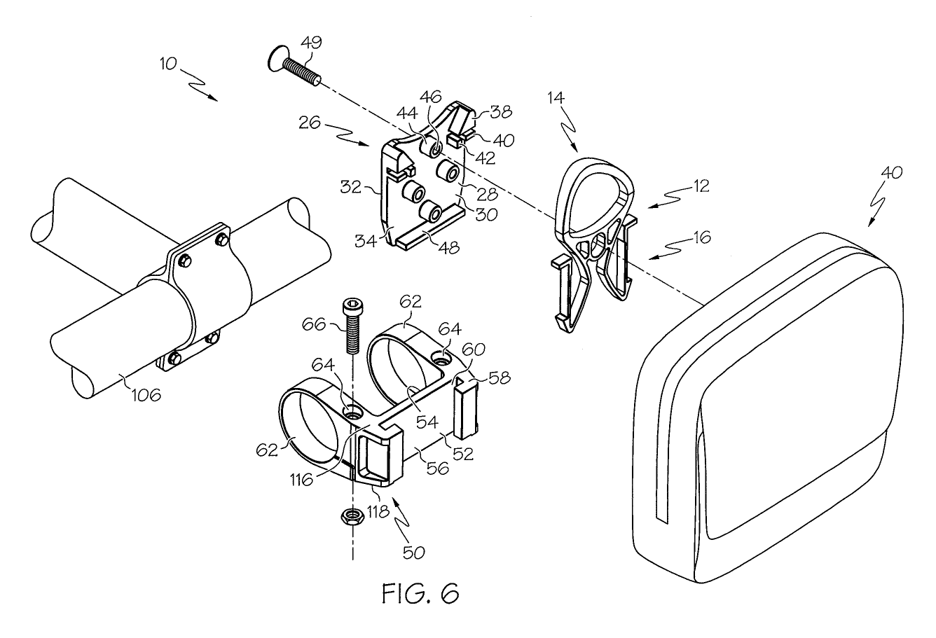

As illustrated in FIGS. 6-8, another embodiment of the device 10 may be used to removably mount accessories to a bicycle's handlebars 106. As shown, the embodiment includes a latching member 12, a retention plate member 26, and a mounting bracket 50.

The mounting bracket 50 is configured for being secured to a tubular member of a bicycle and includes an insertion end 116 and a latching end 118. The mounting bracket 50 has a wall 52 with a first surface 54 and a second surface 56. Protruding from the wall first surface 54 are loop straps 62 configured for being secured to a tubular member of a bicycle. The loop straps 62 can have apertures 64 for receiving bolts 66 in order to clamp the mounting bracket 50 to a tubular member of a bicycle. It will be appreciated by one skilled in the art that the tubular member may be the handlebars 106, a frame member (not shown), or any other portion of a bicycle suitable for attachment. In use, a strip of rubber, acting as a washer, may be placed between the bicycle's tubular member and a loop strap 62. This strip of rubber grips the tubular member and the loop strap 62 thereby impeding the rotation of the mounting bracket 50 about the tubular member. Because bicycle handlebars come in two standard diameters, an additional strip of rubber, or alternatively a thicker strip of rubber, may be necessary to snuggly mount the mounting bracket 50 to the smaller standard diameter handlebars. It will be appreciated by one skilled that the mounting bracket can also be secured by other mounting means including screws, pins, cable ties, wire, welding, clamps, clips, adhesives, or any other means suitable for use with the present invention.

Protruding from the wall second surface 56 of the mounting bracket 50 are flanges 58. The flanges 58 have channels 60 that are configured for slidably receiving the retention plate member 26. As illustrated in FIGS. 6-8, the channels 60 have a width slightly greater than the thickness of the retention plate member side flange portions 34. The mounting bracket 50 is analogous to the mounting bracket 68 from the previously described embodiment in that both mounting bracket 50 and mounting bracket 68 have channels 60, 84 for slidably receiving the retention plate member 26 and latching ends 90, 118 for being engaged by the latching tabs 22.

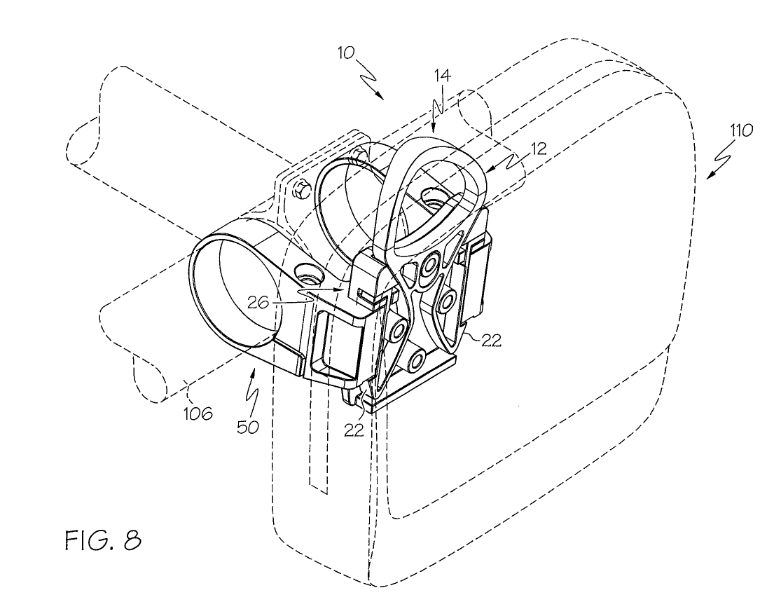

The process for coupling and uncoupling an accessory, such as a bag 110, to and from a tubular member of a bicycle, such as a handlebar 106, is nearly the same as the process described above for coupling and uncoupling an accessory underneath the seat 100 of a bicycle. When a user desires to couple an accessory, such as a bag 108, to the handlebars 106 of a bicycle, the user joins the retention plate 26 (which is secured to the accessory) with the mounting bracket 50 (which is secured to the handlebars 106). In doing so, the user slides the side flange portions 34 of the retention plate 26 into the respective channels 60 of the mounting bracket 50. When initially inserting the side flange portions 34 into the channels 60, the latching tabs 22 of the latching member 12 will engage the channels 60. This engagement forces the latching tabs 22 to be inwardly displaced. When the latching tabs 22 are inwardly displaced, the spring structure 16 becomes deflected. The beveled shape of the latching tabs 22 helps to guide the latching tabs 22 inwardly and transition the spring structure 16 into its deflected state as the latching tabs 22 first enter the channels 60. Once the latching tabs 22 completely pass through the channels 60, the spring structure 16 returns to its natural, undeflected state. When this occurs, the latching tabs 22 snap outwardly to a latching position and engage against latching end 118 of the mounting bracket 50 as shown in FIG. 8. This engagement secures the retention plate member 26 to the mounting bracket 50, which again is secured to the handlebars 106.

When a user desires to uncouple the accessory from the handlebars 106 of the bicycle, the user detaches the retention plate member 26 (which is secured to the accessory) from the mounting bracket 50 (which is secured to the handlebars 106). To do so, the user pulls the latching member handle 14. Again, as illustrated in FIG. 3, when the latching member handle 14 is pulled, the spring structure 16 becomes deflected. Again, this deflectation is caused by the spring structure second ends 114 being held in place by the stop ends 24 while the spring structure first ends 112 are displaced by the movement of the handle 14. As shown in FIG. 3, when the handle 14 is pulled, the cantilever-type leaf springs 20 deflect into a straighter, less arced shape. This deflection causes the latching tabs 22 to retract inwardly to an unlatching position. In turn, the inward retraction of the latching tabs 22 causes them to release and become disengaged from latching end 118 of the mounting bracket 50.

The pulling force applied by the user to the latching member handle 14 to release the latching tabs 22 also acts to pull the retention plate 26 out from the bracket channels 60. Therefore, the latching member 12 and the retention plate 26 can be disengaged and separated from the mounting bracket 50 with a single pulling action. This may allow a user to uncouple an accessory from a bicycle with the use of only one hand.

The components of the device 10, including the latching member 12, the retention plate member 26, the mounting bracket 50, 68, and the rod-engaging member 92 can all be constructed of a plastic such as a nylon resin. More particularly, they may be constructed from DuPont™ Zytel®. The DuPont™ Zytel® material provides the components with ultraviolet (UV) light resistant characteristics and impact resistant characteristics while still allowing the components, most importantly the latching member, to be flexible.

The various mounting device examples shown above illustrate a novel apparatus for mounting accessories to a bicycle. A user of the present invention may choose any of the above mounting devices, or an equivalent thereof, depending upon the desired application. In this regard, it is recognized that various forms of the subject mounting device could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

I claim:

1. A device for removably coupling articles comprising:
a latching member having a spring structure extending from a pull handle to a distal end wherein said distal end has a latching tab protruding therefrom and a deflection arm extending therefrom to a stop end;
a retention plate having a containment area substantially containing said spring structure, said containment area having a handle opening through which said pull handle extends and a tab opening through which said latching tab extends and further having a stop to engage said stop end of the deflection arm adapted for deflecting the deflection arm when said pull handle is pulled to deflect said latching tab from a latching position to an unlatching position; and
a mounting bracket having a channel extending from an insertion end through a latching end, said channel adapted to slidably receive said retention plate when said latching tab is at the unlatching position and retainably couple said retention plate when said latching tab is at the latching position and extending through said latching end.

2. The device of claim 1, wherein said spring structure includes a cantilever-type leaf spring.

3. The device of claim 2, wherein said cantilever-type leaf spring has an arc with a medial inward projecting apex.

4. The device of claim 2, wherein said latching member includes two said latching tabs and two said deflection arms and wherein spring structure of said latching member includes two said cantilever-type leaf springs.

5. The device of claim 1, wherein said latching tab has a wedge shape.

6. The device of claim 1, wherein said retention plate includes a wall having a side flange configured for being slidably received by said mounting bracket channel.

7. The device of claim 1, wherein said retention plate includes standoffs protruding from a wall for creating said containment area between said wall and an article to which said retention plate is attached.

8. The device of claim 1, wherein said deflection arm stop end engages said retention plate stop to deflect said latching tab inwardly from a latching position to an unlatching position when said pull handle is pulled.

9. The device of claim 1, wherein said mounting bracket latching end is configured to be engaged by said latching member latching tab.

10. The device of claim 1, wherein said retention plate includes protrusions for receiving and positioning said deflection arm stop end thereby positioning said latching member with respect to said retention plate.

11. A mounting bracket for removably mounting articles comprising:
a channel extending from an insertion end through a latching end, said channel configured for receiving an assembly having a retention plate and a latching member with a latching tab when said latching tab is at an unlatched position and configured for retainably coupling said assembly when said latching tab is at a latched position; and
a means for mounting said bracket to an object.

12. The mounting bracket of claim 11, wherein said mounting bracket includes two opposing channels.

13. The mounting bracket of claim 11, wherein said latching end is configured to be engaged by said latching tab to secure said assembly to said mounting bracket.

14. The mounting bracket of claim 11, wherein said mounting means is a loop strap clamp configured for clamping to a tubular member.

15. The mounting bracket of claim 11, wherein said mounting means includes recessed portions of said mounting bracket configured for engaging a lower portion of cycle seat frame rods and a rod-engaging member configured for engaging an upper portion of said rods.

16. An assembly for removably coupling articles comprising:
a latching member having a spring structure extending from a pull handle to a distal end wherein said distal end has a latching tab protruding therefrom and a deflection arm extending therefrom to a stop end;
a retention plate having a wall and standoffs protruding from said wall creating a containment area that substantially contains said spring structure between said wall and an article to which said retention plate is attached, said containment area having a handle opening through which said pull handle extends and a tab opening through which said latching tab extends and further having a stop to engage said stop end of the deflection arm adapted for deflecting the deflection arm when said pull handle is pulled to deflect said latching tab from a latching position to an unlatching position; and
wherein said assembly is configured for being slidably received by a mounting bracket having at least one channel.

17. The assembly of claim 16, wherein said spring structure includes a cantilever-type leaf spring with a medial inward projecting apex.

18. The assembly of claim 17, wherein said latching member includes two said latching tabs and two said deflection arms and wherein spring structure of said latching member includes two said cantilever-type leaf springs.

19. The assembly of claim 16, wherein said retention plate wall includes a side flange configured for being slidably received by said mounting bracket channel.

20. The assembly of claim 16, wherein said spring structure, latching tab, and deflection arm all have substantially equal widths and wherein said standoffs have lengths slightly greater than said widths such that latching member is snugly contained between said wall and said article to which said retention plate is attached.
